(19) United States
(12) Patent Application Publication
(10) Pub. No.: US 2008/0263614 A1
(43) Pub. Date: Oct. 23, 2008

(54) METHOD AND APPARATUS FOR TRANSMITTING AND RECEIVING BROADCAST SERVICE DATA IN A DIGITAL BROADCASTING SYSTEM

(75) Inventors: Yiling XU, Suwon-si (KR); Jae-Yeon Song, Seoul (KR); Kook-Heui Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/103,959

(22) Filed: Apr. 16, 2008

(30) Foreign Application Priority Data
Apr. 16, 2007 (KR) 37170/2007

(51) Int. Cl. H04N 7/173

(52) U.S. Cl. 725/118

(57) ABSTRACT

A system and method for transmitting broadcast service data in a digital broadcasting system. The method includes setting a flag indicating a service area representative of coverage where broadcast service data is provided, for each broadcast service; and transmitting broadcast service information including the flag and a Transport Stream (TS) including the broadcast service data.

### PRIORITY

This application claims priority under 35 U.S.C. § 119(a) to a Korean Patent Application filed in the Korean Intellectual Property Office on Apr. 16, 2007 and assigned Serial No. 2007-37170, the disclosure of which is incorporated herein by reference.

### BACKGROUND OF THE INVENTION

1. Field of the Invention

The present invention relates generally to a method and apparatus for transmitting and receiving broadcast service data in a digital broadcasting system, and in particular, to an apparatus and method for transmitting and receiving broadcast service data depending on the coverage where broadcast service data is provided in a digital broadcasting system. Further, the present invention provides an apparatus and method for indicating national services for Mobility Support in a Digital Video Broadcasting-Satellite services to Handheld (DVB-SH) system.

2. Description of the Related Art

FIG. 1 is a diagram illustrating a configuration of a conventional DVB-SH system. Based on the DVB-SH standard, the DVB-SH system provides broad coverage by combining a satellite with terrestrial transceivers.

Referring to FIG. 1, a service & network head-end 102 distributes broadcast content 100, which is provided from a content provider (not illustrated), over a broadcast distribution network 106. More specifically, the service & network head-end 102 can transmit the broadcast content 100 to a DVB-SH satellite 107 over a DVB-SH broadcast head-end 104, the DVB-SH satellite 107 transmitting the broadcast content 100 to a user terminal 112 directly or via a gap filler Tr(b) 108. Additionally, the service & network head-end 102 transmits the broadcast content 100 to a ground-based fixed transmitter Tr(a) 110 or a mobile transmitter Tr(c) 114, e.g., trains and buses, so that the user terminal 112 located in a reception cell 120 can receive the broadcast. In the signal flow illustrated in FIG. 1, reference numeral 116 represents a path over which DVB-SH signals are transmitted, and reference numeral 118 represents a path over which the broadcast content 100 is distributed.

The DVB-SH standard is generally classified into two types of modes: a DVB-SH-A system supporting an Orthogonal Frequency Division Multiplexing (OFDM)-based satellite transmitter mode and a DVB-SH-B system supporting an OFDM-based terrestrial transmitter mode and a Time Division Multiplexing (TDM)-based satellite transmitter mode.

The conventional DVB-SH-A system and the conventional DVB-SH-B system, the satellite supports only national services. In the DVB-SH-A system, the service provider generates and provides different Transport Streams (TSs) for national services and local services, and in the DVB-SH-B system, the service provider generates one common TS for national services and local services, and transmits it to satellite and terrestrial transmitters after removing the services that the corresponding transmitters do not support, thereby enabling the transmitters to support different services. The term ‘national services’ refer to broadcast services provided nationwide in common, and the term ‘local services’ refer to broadcast services provided uniquely in corresponding areas. That is, in the DVB-SH-B system, a satellite transmitter removes from the common TS the services, which are not supported by the satellite, before transmission, and a terrestrial transmitter removes from the common TS the services, which are provided in the corresponding area, before transmission to the terminal.

The DVB-SH system has a problem that it should support the handover caused by simultaneous transmission of the same national services to the satellite and the terrestrial transmitters. That is, in both the DVB-SH-A and DVB-SH-B systems, only the national services are supported by the satellite. However, the supported services vary depending on through which path (formed by satellite and/or terrestrial transmitter) the DVB-SH services are received.

As illustrated in FIG. 1, the same TS can be transmitted via the satellite and the terrestrial transmitter. When the TS is transmitted via the satellite, the TS carries the national services, and when the TS is transmitted via the terrestrial transmitter, the TS carries both the national services and the local services.

Therefore, the DVB-SH system should determine how to distinguish the national services from the local services. In addition, the user terminal needs to determine when it will consider mobility, and to this end, the user terminal should know TS available in several areas, and should also known which broadcast services among the national services and local services are carried by the TS.

Particularly, for the national services, a user terminal needs a particular mechanism to seamlessly receive the currently received national services both when the user terminal moves to a satellite cell area where only the satellite signals are received and when it moves to the terrestrial cell.

That is, when a terminal considers handover as it leaves the current cell and moves to the satellite cell or another terrestrial cell, the services presently being provided through Program Specific Information/Service Information (PSI/SI) information may not be provided in the cell to which the terminal moves. However, in light of the current configuration of the DVB-SH system, it is possible that the terminal cannot know that the currently received services are national services. Particularly, in the DVB-SH-A system and DVB-SH-B system where the satellite generates a common TS, removes corresponding local services from the common TS, and transmits only the national services, since TS_id of the common TS is maintained even when the actual contents of the TS have changed due to the removal of the services, it is not then possible to determine which services in the corresponding TS are national services. Therefore, there is a need for a system and method capable of identifying the national services.

### SUMMARY OF THE INVENTION

The present invention has been designed to address at least the problems and/or disadvantages and to provide at least the advantages described below. Accordingly, an aspect of the present invention is to provide an apparatus and method providing seamless broadcast services during handover of a terminal in a digital broadcasting system.

Another aspect of the present invention is to provide an apparatus and method for transmitting and receiving broadcast service data according to a coverage area in which broadcast service data is provided, in a digital broadcasting system.

Another aspect of the present invention is to provide an apparatus and method for seamlessly providing national services in a digital broadcasting system.

Another aspect of the present invention is to provide an apparatus and method for transmitting and receiving broadcast service information indicating if broadcast services included in a transport stream are national services, in a digital broadcasting system.

Another aspect of the present invention is to provide an apparatus and method for transmitting and receiving broadcast service data according to a flag indicating that broadcast services included in a transport stream are national services, in a digital broadcasting system.

In accordance with an aspect of the present invention, there is provided a method for transmitting broadcast service data in a transmission system of a digital broadcasting system. The method includes setting a flag indicating a service area representative of coverage where broadcast service data is provided, for each broadcast service; and transmitting broadcast service information including the flag and a Transport Stream (TS) including the broadcast service data.

In accordance with another aspect of the present invention, there is provided a method for transmitting broadcast service data in a broadcasting system providing a broadcast service in the form of a Transport Stream (TS), wherein broadcast service information of the TS includes information used for identifying each broadcast service. The method includes, when all broadcast service data included in the TS is provided nationwide, generating information indicating that all the broadcast service data included in the TS is broadcast service data provided nationwide; including the generated information in broadcast service information of the TS; and transmitting the broadcast service information along with each broadcast service data.

In accordance with another aspect of the present invention, there is provided a method for receiving broadcast service data in a terminal of a digital broadcasting system. The method includes, when there is a need for handover while receiving broadcast service data, checking if a flag is set in broadcast service information, which indicates if the currently received broadcast service data is for a national service, and performing handover according to the check result; and when broadcast service data previously received before the handover is for a national service, receiving a Transport Stream (TS) carrying each broadcast service data, and demodulating the broadcast service data previously received before the handover in the received TS.

In accordance with another aspect of the present invention, there is provided a method for receiving broadcast service data in a broadcasting system providing a broadcast service in the form of a Transport Stream (TS), wherein broadcast service information of the TS includes information used for distinguishing each broadcast service. The method includes, when there is a need for handover while receiving broadcast service data, checking if information is set, which indicates if all broadcast service data included in the currently received TS is for a national service provided nationwide, and performing handover according to the check result; and when all broadcast service data included in the TS previously received before the handover is for a national service, receiving a TS carrying each broadcast service data and demodulating the broadcast service data previously received before the handover in the received TS.

In accordance with another aspect of the present invention, there is provided an apparatus for transmitting broadcast service data to a user terminal in a digital broadcasting system. The apparatus includes a flag generator for setting a flag indicating a service area where broadcast service data to be transmitted to the user terminal is provided, for each broadcast service; and a transmission unit for multiplexing broadcast service information including the flag and a Transport Stream (TS) including the broadcast service data, and transmitting the multiplexed TS.

In accordance with another aspect of the present invention, there is provided a terminal apparatus for receiving broadcast service data in a digital broadcasting system. The terminal apparatus includes a reception unit for receiving a Transport Stream (TS), and demodulating broadcast service data and broadcast service information included in the TS; a demultiplexer for demultiplexing broadcast service information necessary for receiving the demodulated broadcast service data, and broadcast service data to be provided to a user; a flag checker for checking if a flag indicating that the received broadcast service data is for a national service is inserted into the demultiplexed broadcast service information; and a controller for controlling the reception unit so as to perform handover when there is a need for handover, and if the flag is inserted, to demodulate broadcast service data previously received before the handover in a TS received after the handover.

### BRIEF DESCRIPTION OF THE DRAWINGS

The above and other aspects, features, and advantages of the present invention will become more apparent from the following detailed description when taken in conjunction with the accompanying drawings in which:

FIG. 1 is a diagram illustrating a configuration of a conventional DVB-SH system;

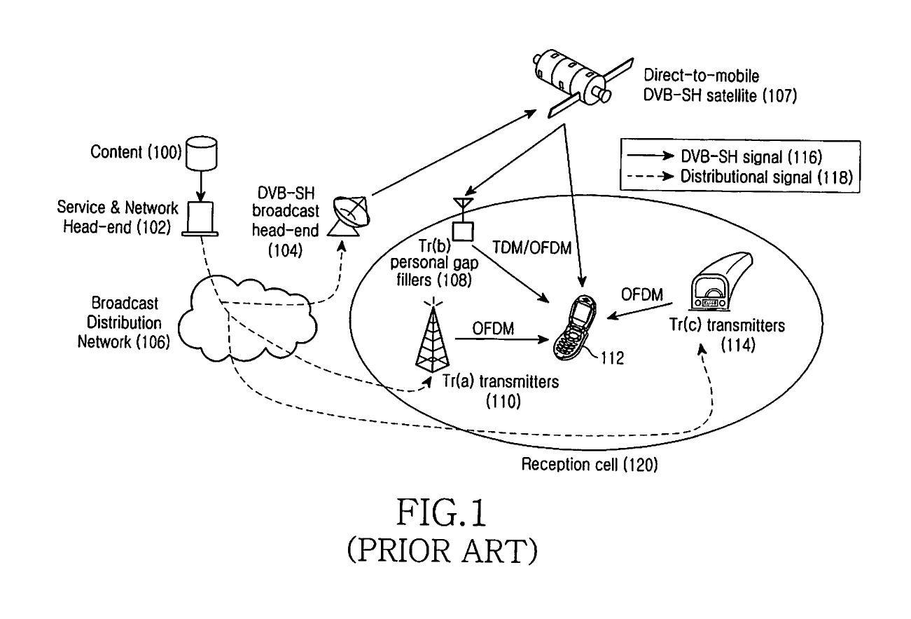

FIG. 2 is a diagram illustrating a process in which a server generates a TS including national services and local services and transmits the TS through terrestrial and satellite transmitters in a DVB-SH system to which the present invention is applied;

FIG. 3A is a diagram illustrating architecture of a DVB-SH-A system to which the present invention is applied;

FIG. 3B is a diagram illustrating architecture of a DVB-SH-B system to which the present invention is applied;

FIG. 4 is a diagram illustrating a handover procedure of a terminal based on Scenario 1, when a national flag is used according to an embodiment of the present invention;

FIG. 5 is a diagram illustrating a conventional handover procedure based on Scenario 1, when a national flag proposed by the present invention is not used;

FIG. 6 is a flowchart of a transmission system for generating TS based on Scenario 1 according to an embodiment of the present invention;

FIG. 7 is a diagram illustrating a handover procedure of a terminal based on Scenario 2, when a national flag is used according to an embodiment of the present invention;

FIG. 8 is a diagram illustrating a general handover procedure based on Scenario 2 when the national flag proposed by the present invention is not used;

FIG. 9 is a flowchart of a transmission system for generating and transmitting a TS based on Scenario 2 according to an embodiment of the present invention;

FIG. 10 is a diagram illustrating a structure of a transmission system according to an embodiment of the present invention;

FIG. 11 is a diagram illustrating a structure of a user terminal according to an embodiment of the present invention; and

FIG. 12 is a diagram illustrating an operation in which a user terminal performs handover according to an embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

However, before a description of the present invention is given, a brief description will be made of DVB-SH-A and DVB-SH-B, which are two standards of the DVB-SH system.

In the DVB-SH-A system, national services are transmitted by the satellite and terrestrial transmitters, and the local services unique to a corresponding area are transmitted by the terrestrial transmitters.

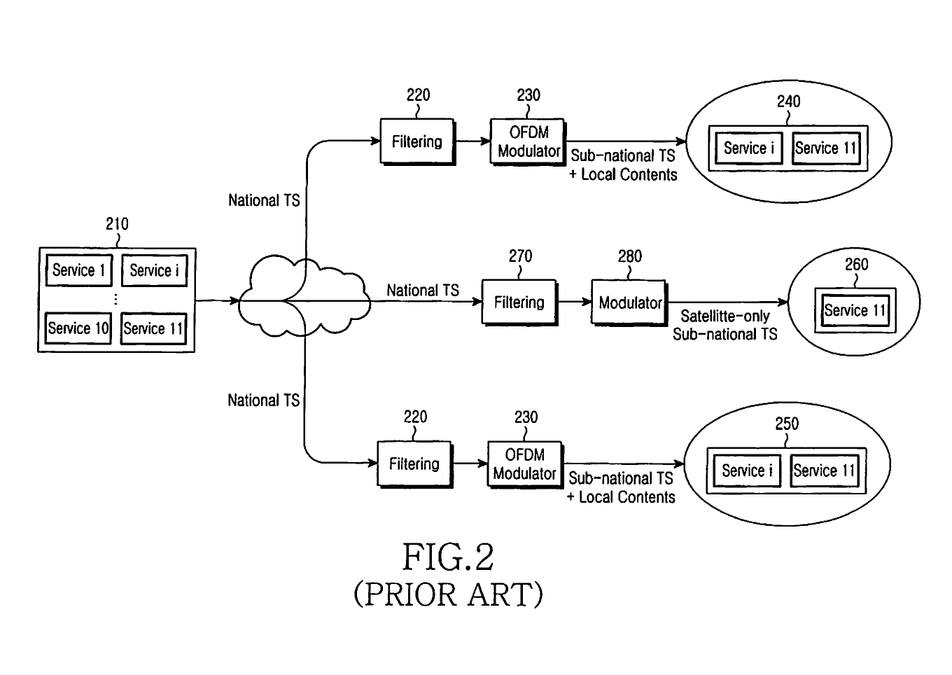

FIG. 2 is a diagram illustrating a process in which a server generates a Transport Stream (TS) including national services and local services and transmits the TS through terrestrial and satellite transmitters in a DVB-SH system to which the present invention is applied. Referring to FIG. 2, reference numeral 210 represents a TS generated by a broadcast server (not shown), and it can be seen that the TS 210 includes Service 1 to Service 11. More specifically, reference numeral 210 represents a frame containing all broadcast services generated by the server, and frame 210 is transmitted in a National TS. Service 1 to Service 10 are services specific to a corresponding area, and Service 11 is a national service.

A filtering unit 220 and an OFDM modulator 230 filter and modulate the received National TS, respectively, thereby filtering the services specific to the corresponding area from the National TS. As a result, a local service of Service i (where i is one of 1 to 10) and a national service, i.e., Service 11, are transmitted in area 240, and the same services are transmitted in area 250. Such services are transmitted to a user terminal through associated terrestrial transmitters. In area 260, all local services are filtered from the National TS by filtering unit 270 and modulator 280, such that only the national service (Service 11) is transmitted. Service 11 is transmitted to the terminal via the satellite.

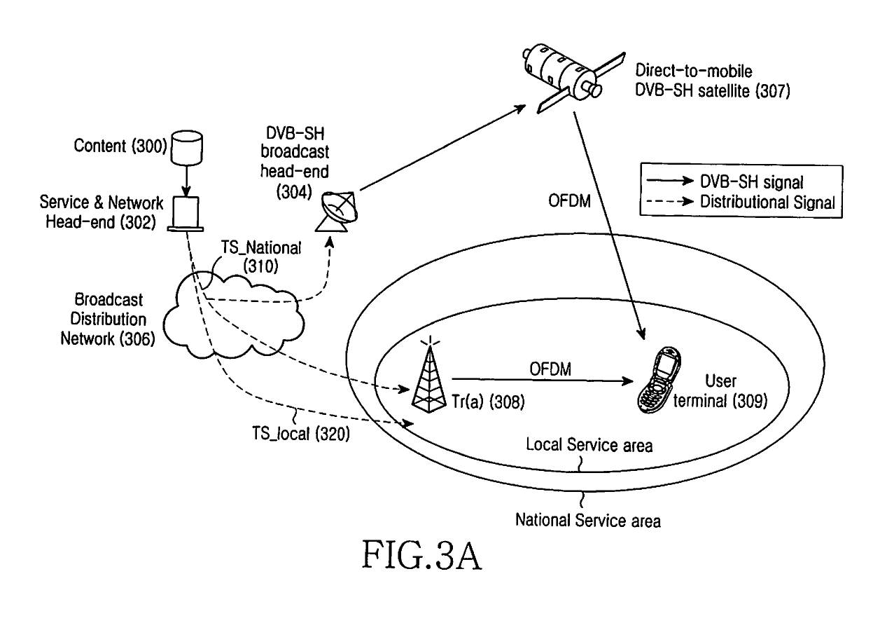

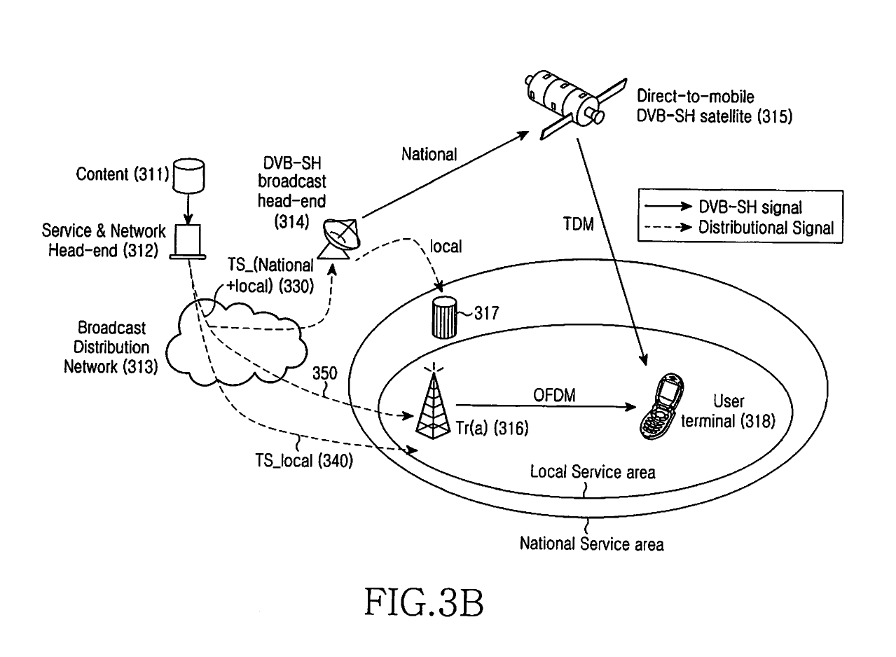

FIG. 3A is a diagram illustrating architecture of a DVB-SH-A system to which the present invention is applied, and FIG. 3B is a diagram illustrating architecture of a DVB-SH-B system to which the present invention is applied. Referring to FIG. 3A, a service & network head-end 302 generates, using generated content 300, a TS_national 310, which is a TS provided to a national service network, and a TS_local 320, which is a TS provided to a local service network, and transmits them to a broadcast distribution network 306. The TS_national 310 is a TS including a national service(s), and is transmitted via a satellite and/or a terrestrial transmitter. The TS_local 320 is a TS including a local service(s), and in the DVB-SH-A system, the national service and the local service are transmitted in another TS. The TS_national 310 is transmitted to a DVB-SH satellite 307 via a DVB-SH broadcast head-end 304, and the DVB-SH satellite 307 transmits the received TS to a user terminal 309. Upon receipt of the TS_local 320, the ground-based fixed transmitter 308 transmits the received TS to the user terminal 309 located in a local service area.

In FIG. 3B, a service & network head-end 312 transmits a content 311 to a broadcast distribution network 313, and the broadcast distribution network 313 receives a TS_(national+local) 330, which is a common TS including a local service and a national service, and a TS_local 340, which is a TS generated as a new local service, is needed as a local service, which is different from the local service included in the TS_(national+local) 330. The TS-(national+local) 330 represents one TS in which a national service and a local service are included.

For the TS_(national+local) 330, before it is transmitted to a satellite 315, local services are filtered from it as shown by reference numeral 317 and only the national service is transmitted to the satellite 315. The satellite 315 directly transmits the received national service to a user terminal 318. A ground-based fixed transmitter TR(a) 316 provides the user terminal 318 located in the local service area, with the local service TS_local 340 and a TS_(national+local) 350, which is a common TS including the national service and the local service.

Embodiments of the present invention insert a predetermined flag (national flag) into broadcast service information or Program Specific Information/Service Information (PSI/SI) before transmission in order to notify that the service currently being provided to a user terminal is a national service. That is, in embodiments of the present invention, a transmitter sets a flag to a predetermined value, indicating whether the coverage where each broadcast service data included in a transmission TS is provided corresponds to a national area or a local area, and inserts the flag into the PSI/SI of the TS before transmission, and the user terminal checks during handover if there is a flag inserted into PSI/SI of the received TS and if the flag is set to a predetermined value to thereby determine whether the currently received broadcast service is a national service or a local service, and performs the corresponding procedure. That is, when the currently received broadcast service is a national service, the user terminal can receive the same service even after moving, as it can perform handover without a separate procedure. When the currently received broadcast service is a local service, the user terminal should perform a separate procedure, such as sending a request to a server in order to continuously receive the same service as the service previously received before handover. Because the separate procedure for the service continuity of the local service departs from the scope of the present invention, a description thereof will be omitted herein. When the user terminal is receiving the local service, if there is no information on the flag, because the corresponding service is interrupted when the user terminal leaves the corresponding local cell, it is efficient to insert the flag so as to give the opportunity that the user terminal can perform a procedure for receiving the corresponding service.

Embodiments of the present invention, described below, are divided according to the method of inserting the national flag into the broadcast service information.

The term ‘scenario’ is used herein as a handover operation of a user terminal regardless of the embodiments. That is, embodiments of the present invention are divided according to the method of inserting the flag into PSI/SI, thereby indicating the inclusion of a national service in TS.

### 1. Embodiment 1

### Include a Flag Indicating a National Service in a Network Information Table (NIT) Table Before Transmission

### Embodiment 1-1

### Insert a National Flag into the Nit Table Separately for Each Broadcast Service

The national flag is a 1-bit indicator, and when it is set to a predetermined value ‘1’ or ‘0’ indicating a national service, this indicates that the broadcast service corresponding to the national flag is a national service. When the national flag is set to a predetermined value indicating the national service, it is possible to indicate that a particular service among the services included in a TS is a national service (Embodiment 1-1), and it is also possible to indicate that all services in the corresponding TS are national services, according to the position of the flag (Embodiment 1-2). For example, it is preferable for the DVB-SH-A system to indicate that all services in the TS are national services, and it is preferable for the DVB-SH-B system to indicate if each broadcast service included in the TS is a national service. For example, if the national flag is set to ‘1’, it may mean that the TS including broadcast service information is for a national service.

Therefore, embodiments of the present invention, by setting the national flag to a predetermined value, can indicate the coverage where the broadcast service is provided, i.e., indicate whether the broadcast service is a broadcast service provided nationwide or a broadcast service provided separately in each area.

Table 1 shows an example of a national flag inserted into an NIT table according to Embodiment 1-1 of the present invention. As shown in Table 1, a ‘national flag’ is inserted into an NIT table according to Embodiment 1-1 of the present invention. In Table 1 to Table 3, the remaining elements except for ‘national flag’ are defined in ETSI EN 300468 (DVB: Specification for service information in DVB systems), so a description thereof will be omitted.

TABLE 1

Syntax
Service_list_descriptor( ) {

Descriptor_tag
Descriptor_length
For(i=0; i<N; i++){
Service_id
Service_type
National_flag
}

}

As shown in Table 1, a TS transmission side, by setting National_flag to a predetermined value, can indicate whether a broadcast service corresponding to Service_id is a national service provided nationwide or a local service provided separately in each area, and a terminal receiving the TS can determine whether the broadcast service corresponding to Service_id is a national service or a local service according to the value to which National_flag is set.

There are two methods for indicating whether broadcast services included in the TS are national services or local services with the use of National_flag. A first method inserts the flag into the PSI/SI of the TS only for the broadcast service of a national service, and a second method sets the flag to a value of ‘0’ or ‘1’ to distinguish the broadcast service of a national service from the broadcast service of a local service, and inserts the set flag into the PSI/SI. The two methods are both available in the present invention.

### Embodiment 1-2

### Insert a Global Descriptor into an NIT Table to Notify a National Service

Embodiment 1-2, unlike Embodiment 1-1, notifies that the broadcast service included in the corresponding TS is a national service by using a global descriptor. That is, Embodiment 1-2 notifies that all services in the corresponding TS are national services, and Embodiment 1-1 is different in that it attaches a flag separately for each service in the NIT table. That is, in Embodiment 1-1, since some services include a national flag and some services include no flag, it is different from the global descriptor indicating that all broadcast services included in the TS are national services. Embodiment 1-2 of the present invention is a scheme for inserting into the NIT table a global descriptor Global_descriptor( ) indicating that all services in the TS transmitted to the user terminal are national services. Table 2 shows an example of Global_descriptor( ) according to Embodiment 1-2 of the present invention.

TABLE 2

Syntax
Global_descriptor( ){

Descriptor_tag
Descriptor_length
Global_flag
Reserved

}

In Table 2, Descriptor_tag is a value of a particular number assigned to recognize the corresponding descriptor. For example, for Service_list_descriptor, because its tag has a value ‘0x41’, it is possible to distinguish each descriptor. Descriptor_length is a field indicating a length of a data part of the corresponding descriptor. Global_flag is a flag indicating if the broadcast service transmitted by the corresponding TS is a national service.

Table 3 shows an example of an NIT table into which a global descriptor of the present invention is inserted.

TABLE 3
NIT (actual)

Network_id: 1

Transport_stream_id: 1
Original_network_id: 1
Terrestrial_delivery_system_descriptor
Cell_list_descriptor
Cell_frequency_link_descriptor
Global_descriptor

### 2. Embodiment 2

### Insert a Flag into a Service Description Table (SDT) Table Indicating that the Broadcast Service is a National Service

Embodiment 2, which is another embodiment for a method of inserting a national flag separately for each broadcast service, inserts a national flag into an SDT table, and the SDT table is as shown in Table 4. Table 4 shows an example of an SDT table into which a national flag for each broadcast service is inserted according to Embodiment 2 of the present invention. In Table 4, the remaining elements, except for the ‘national flag’ indicating whether a corresponding service is a national service separately for each broadcast service included in the TS, are defined in ETSI EN 300468 (DVB: specification for service information in DVB systems).

TABLE 4

Syntax
service_description_section( ){

table_id
section_syntax_indicator
reserved_future_use
reserved
section_length
transport_stream_id
reserved
version_number
current_next_indicator
section_number
last_section_number
original_network_id
reserved_future_use
for (i=0; i<N; i++){

service_id
National_flag
reserved_future_use
EIT_schedule_flag
EIT_present_following_flag
running_status
free_CA_mode
descriptors_loop_length
for (j=0; j<N; j++){

descriptor( )

}

}
CRC_32

}

By setting National_flag to a predetermined value as shown in Table 4, a TS transmission side can indicate that the broadcast service corresponding to Service_id is a national service, and a terminal receiving the TS can determine that the broadcast service corresponding to Service_id is a national service.

### 3. Embodiment 3

### Insert a National Flag into an Internet Protocol/Media Access Control (IP/MAC) Notification Table (INT) Table

Embodiment 3 of the present invention inserts a national flag into an INT table separately for each broadcast service, and the INT table is shown in Table 5. In Table 5, ‘national flag’ indicates if the corresponding broadcast service is a national service separately for each service included in the TS according to Embodiment 3 of the present invention, and the remaining elements, except for the ‘national flag’, are defined in ETSI EN 300468 (DVB: specification for service information in DVB systems).

TABLE 5
INT

platform_id

IP/MAC_platform_name_descriptor( )
IP/MAC_platform_prov_name_descrioptor( )
Target_IP_address_descriptor( )
IP/MAC stream_location_descriptor( )
network_id
orig_network_id
transport_stream_id
service_id
component_tag
National_flag

By setting National_flag to a predetermined value before transmission as shown in Table 5, a TS transmission side can indicate that the broadcast service corresponding to Service_id is a national service.

A definition of the existing field values of the INT and SDT tables in Embodiment 2 and Embodiment 3 of the present invention follows the definition of ETSI EN 300468 and its associated specifications, so a description of the existing field values will be omitted herein.

As presented in the above-described embodiments, the present invention inserts a national flag into PSI/SI information and transmits it to a user terminal, thereby enabling the user terminal to determine which broadcast service among the broadcast services transmitted in the TS is a national service. This information is utilized by the user terminal when it moves to another cell while receiving the broadcast service.

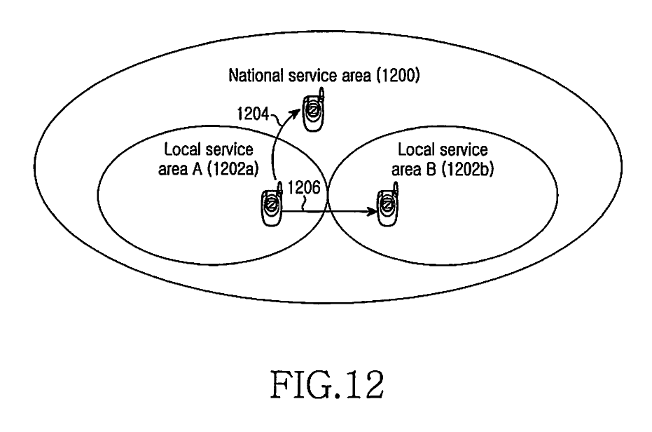

FIG. 12 is a diagram illustrating an operation in which a user terminal performs handover according to an embodiment of the present invention. Referring to FIG. 12, reference numeral 1200 represents the coverage area in which the national broadcast service is provided, i.e., represents a national service area, which is a satellite cell where a national service is provided by the satellite. Reference numeral 1202a and 1202b represent local service areas, which are terrestrial cells, where local services or national services are provided by means of the terrestrial transmitter. The present invention considers a handover situation for the case in which the user terminal moves from the terrestrial cell A 1202a to the satellite cell 1200, as illustrated by reference numeral 1204. Additionally, the present invention considers the case in which the user terminal moves from the terrestrial cell A 1202a to the terrestrial cell B 1202b, as illustrated by reference numeral 1206.

The present invention insets a flag or a global descriptor into the PSI/SI in order to indicate that a broadcast service included in TS is a national service, before transmission. Consequently, a user terminal can determine if the received broadcast service is a national service.

Therefore, if the previously received broadcast service is a national service, because the user terminal knows that the previously received broadcast service is provided even after performing handover, the user terminal, when it is receiving a national service, has no need to search PSI/SI to determine if a TS received after handover includes an identifier of the broadcast service received before handover even though the user terminal moves to another cell as illustrated in FIG. 12, thereby making it possible to provide seamless broadcast service without time delay.

If the service the user terminal was receiving is a local service, the user terminal can receive the corresponding local service in another area over a communication network by sending a request to a server before moving to another cell. The user terminal cannot continuously receive the corresponding local service in another cell unless it receives additional information indicating that a service having a certain service ID in another cell is the same as the currently received service. Therefore, with the use of the national flag or global descriptor of the present invention, the terminal is notified that the corresponding service is a local service, enabling the terminal to perform the foregoing additional procedure before handover. The foregoing additional procedure for continuing the local service is not described herein.

Next, a description will be made of an operation of a user terminal according to an embodiment of the present invention.

Scenarios 1 and 2 described below are used regardless of embodiments of the present invention as described above. That is, embodiments of the present invention can be applied to the following handover scenarios according to the actual network configuration.

Scenario 1 corresponds to the case in which PSI/SI of a satellite cell is different from PSI/SI of a terrestrial cell, and in this case, PSI/SI information is updated when the user terminal moves from the terrestrial cell area to the satellite cell area.

Scenario 2 corresponds to the case in which PSI/SI of the satellite cell is the same as PSI/SI of the terrestrial cell, and in this case, PSI/SI information is not updated when the user terminal moves from the terrestrial cell area to the satellite cell area.

Herein, the term ‘terrestrial cell’ is an area in which TS is transmitted by a terrestrial transmitter, and the term ‘satellite cell’ is an area in which TS is transmitted by the satellite. Generally, the satellite cell area has a broader coverage than the terrestrial cell area.

Scenario 1: In this scenario, the user terminal is receiving a DVB-SH service via a terrestrial transmitter. The user terminal can receive only the satellite service as it leaves the terrestrial cell area and enters the satellite cell area. This means that though the user terminal can no longer receive the local service as it leaves the local service area, the user terminal moves to the national service area where it can receive only the satellite service.

Herein, the term ‘satellite service’ is a broadcast service provided from the satellite, and the term ‘terrestrial service’ is a broadcast service provided via the terrestrial transmitter. It is assumed in Scenario 1 that a PSI/SI signal transmitted in the terrestrial cell is different from a PSI/SI signal transmitted in the satellite cell.

However, in Scenario 2, a PSI/SI signal is not updated when the user terminal moves from the terrestrial cell area to the satellite cell area. That is, in Scenario 2, PSI/SI used in the terrestrial cell matches PSI/SI used in the satellite cell. The scenarios are divided herein according to whether PSI/SI update is performed or not because the handover now defined in Convergence of Broadcasting and Mobile Service (DVB-CBMS) Workgroup is described as an operation performed in an IP platform. That is, one or several networks can exist in one UP platform.

When user terminal inter-cell movement is made within one network, there is no need for PSI/SI update, and when the inter-cell movement is inter-network movement, there is a need for PSI/SI update. That is, in operation, there are two possible cases, on in which PSI/SI is updated and one in which PSI/SI is not updated. Therefore, a description thereof will be made separately for each scenario.

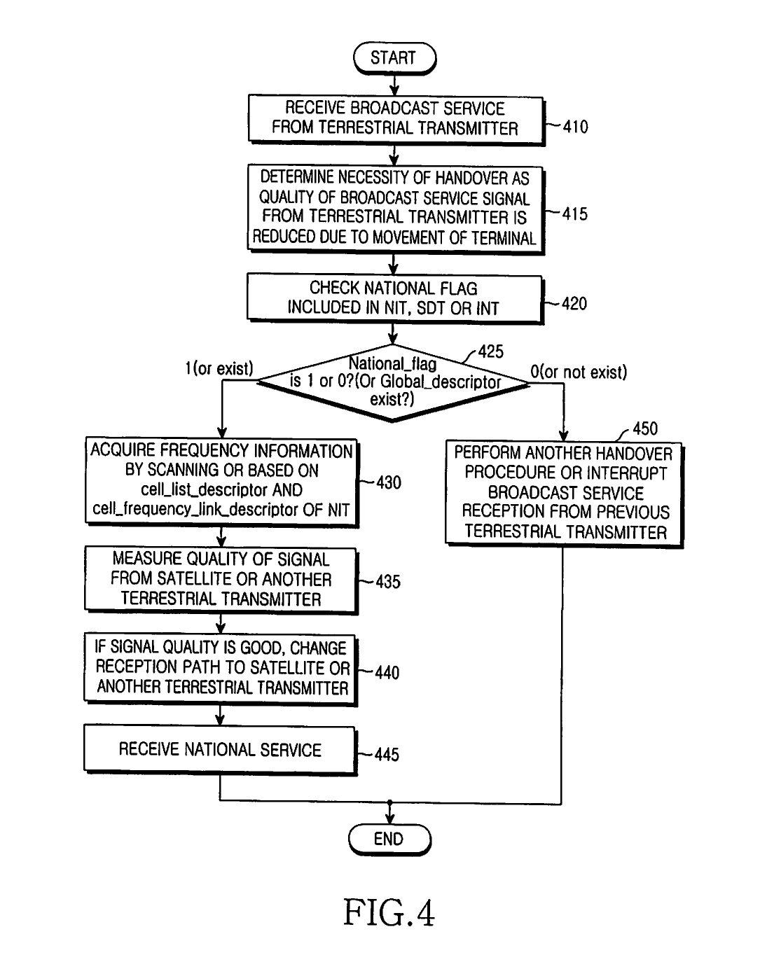

FIG. 4 is a diagram illustrating a handover procedure of a terminal based on Scenario 1, wherein a national flag is used according to an embodiment of the present invention. The present invention can be applied when the terminal performs handover and also when the terminal first accesses a network and receives a broadcast service from the network.

In step 410, a user terminal is receiving a broadcast service from a terrestrial transmitter of a local cell where it is currently located. In step 415, when the user terminal leaves a local service area which is a cell area where the broadcast service is provided, a quality of the signal received from the terrestrial transmitter is reduced, raising the need for handover to the satellite or another terrestrial transmitter. The user terminal searches in step 420 at least one of the NIT, SDT, and INT tables proposed above by the present invention, and checks a national flag or a global descriptor in step 425. The user terminal performs the following operation according to a set value (‘0’ or ‘1’) of the national flag or the presence/absence of the global descriptor in PSI/SI.

In step 425, the user terminal can previously determine whether the currently received broadcast service is a local service or a national service using the national flag. If it is determined in step 425 that the currently received broadcast service is a national service, the user terminal can continuously receive the same service as the broadcast service previously received from the previous terrestrial transmitter by changing the path through which the broadcast service is received to the satellite or another terrestrial transmitter after handover.

If it is determined in step 425 that the national flag is set to ‘1’ or the global descriptor exists in PSI/SI, the user terminal, perceiving that the received broadcast service is a national service, acquires frequency information of the broadcast service it will receive after handover, by means of Cell_list_descriptor and Cell_frequency_link_descriptor of NIT in PSI/SI or by means of scanning in step 430. Step 430 is an operation needed to receive a broadcast service for the national service provided from the satellite when the terminal moves to and accesses the national service network while receiving the broadcast service corresponding to the local service, or to receive a broadcast service for the national service when the terminal performs handover to another local service area.

In step 435, the terminal checks a quality of the signal from the satellite or another terrestrial network using the frequency information acquired in step 430. In step 435, if the signal quality is greater than or equal to a predetermined value, the user terminal changes its reception path to the satellite or the terrestrial transmitter in step 440. In step 445, the user terminal continuously receives the broadcast service, and updates PSI/SI information necessary for receiving the previous broadcast service, with PSI/SI of the TS received through a new reception path. Further, in step 445, the user terminal performs handover to the satellite or another terrestrial transmitter, and continuously receives the previously received national service using the updated PSI/SI. However, the user terminal has no need to search PSI/SI of the newly received TS to determine whether the broadcast service previously received before handover is included in the newly received TS. Therefore, the user terminal, when receiving the national service, can seamlessly receive the broadcast service.

However, if it is determined in step 425 that the corresponding service is a local service, in step 450, the terminal attempts another handover procedure or ends the operation of receiving the broadcast service from the previous terrestrial transmitter. That is, by using the information indicating that the corresponding service is a local service, the user terminal can attempt another handover procedure before the reception of the corresponding local service is interrupted due to the inter-cell movement.

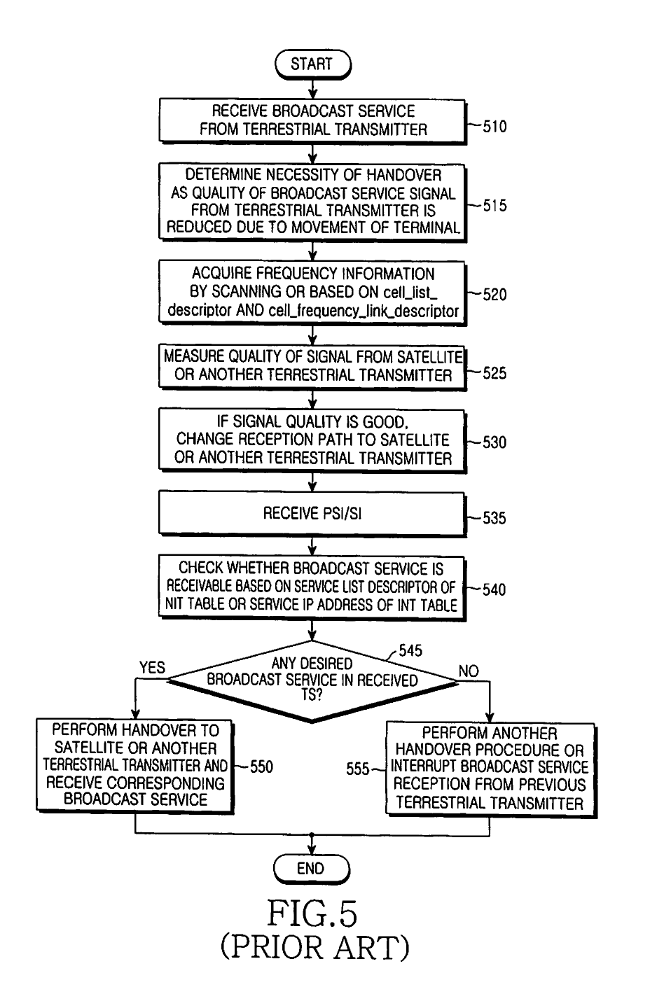

FIG. 5 is a diagram illustrating a conventional handover procedure based on Scenario 1 when a national flag proposed by the present invention is not used. Referring to FIG. 5, in step 510, a user terminal is receiving a broadcast service from a terrestrial transmitter of a local cell where it is currently located. In step 515, when a quality of the signal received from the terrestrial transmitter is less than a predetermined threshold as the user terminal leaves the local cell area, the user terminal determines handover. In this case, the user terminal cannot determine whether the currently received service can be continuously received even after it enters the satellite cell area or another terrestrial cell area. This is because the terminal cannot determine whether the currently received service is a national service or a local service. In order to determine whether the currently received service is a national service or a local service, in step 520, the user terminal acquires frequency information of a satellite signal or another terrestrial transmitter signal from Cell_list_descriptor and Cell_frequency_link_descriptor of NIT included in PSI/SI or by scanning. In step 525, the user terminal checks a quality of the satellite signal or another terrestrial transmitter signal. If the quality of the satellite signal or another terrestrial transmitter signal is greater than or equal to a predetermined value, the user terminal changes the reception path of the service to the satellite signal or another terrestrial transmitter signal in step 530, and receives PSI/SI transmitted from the satellite or another terrestrial transmitter in step 535.

In step 540, the user terminal checks a service list descriptor of an NIT table in the PSI/SI newly received in step 535 or a service IP address of an INT table, and determines from acquired information whether the broadcast service is receivable.

In step 545, the user terminal determines if a desired broadcast service (broadcast service previously received before handover) exists in the TS received from the satellite or another terrestrial transmitter, and if the desired broadcast service exists, the user terminal receives the corresponding broadcast service from the satellite or another terrestrial transmitter in step 550. However, if the desired service does not exist in step 545, the user terminal ends handover or performs another handover procedure in step 555. Because step 555 departs from the main concept of the present invention, a description thereof is briefly given.

According to DVB-H implementation guideline (ETSI TR 102 377), 10 sec or 30 sec is required for the minimum transmission period of the NIT table and the INT table. This means that in the worst case, the user terminal should wait 30 sec or longer to determine whether the broadcast service previously received before handover exists in the TS transmitted from the cell to which it performed handover. When the service is a national service, the service continuity is possible after a lapse of an update time for the PSI/SI as handover is possible. However, when the service is a local service, the user terminal wastes time determining the possibility of the service continuity, and the corresponding local service is already unreceivable after inter-cell movement. That is, for the continuous reception of the local service, information indicating that the corresponding service is a local service should be provided to the terminal before the inter-cell movement is made.

A comparison between the flowcharts of FIG. 4 and FIG. 5 will be made below.

As a national flag is inserted in FIG. 4 according to an embodiment of the present invention, the user terminal, even when receiving a broadcast service from the satellite or another terrestrial transmitter, can determine if it can continuously receive the corresponding service even after its handover, and can previously acquire its associated access information. Therefore, the user terminal can save the time required for handover and its power according to an embodiment of the present invention. That is, as illustrated in FIG. 4, the present invention has no need for the process of determining whether the service previously received before handover exists in the newly received TS(step 540 of FIG. 5), thereby making it possible to seamlessly provide the broadcast service even after handover.

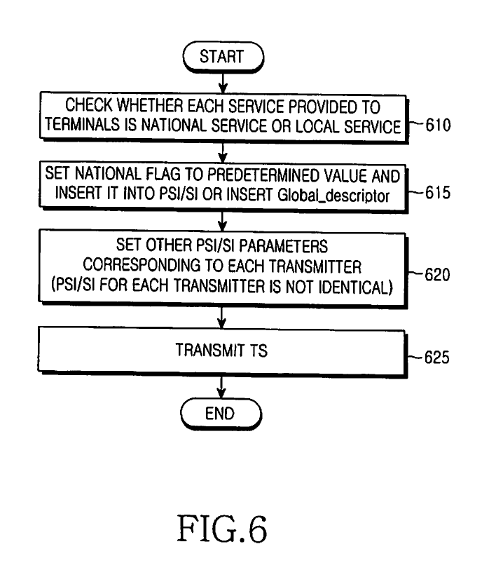

FIG. 6 is a flowchart of a transmission system for generating TS based on Scenario 1 according to an embodiment of the present invention. The transmission system includes the elements 302 and 306 as illustrated in FIG. 3A, and the elements 312 and 313 as illustrated in FIG. 3B. The transmission system according to an embodiment of the present invention adds an operation of inserting a national flag indicating the national service during PSI/SI generation in the DVB-SH system.

In step 610, the transmission system determines whether each broadcast service provided to user terminals is a national service or a local service. If it is determined that the broadcast service is a national service, the transmission system sets in step 615 a national flag to a predetermined value and inserts it into an NIT, SDT, or INT table for each national service, or inserts a global descriptor into the NIT table. In step 620, the transmission system sets other PSI/SI parameters corresponding to each transmitter, and PSI/SI corresponding to each transmitter is not identical. In step 625, the transmission system transmits TS including the set national flag or the global descriptor-inserted PSI/SI.

Scenario 2 corresponds to the case in which PSI/SI is not updated when the terminal enters the satellite cell's area. As stated above, all embodiments of the present invention can be applied to each scenario.

The TS transmitted by the satellite and the TS transmitted by the terrestrial transmitter have the same PSI/SI. Therefore, unless a common TS including a local service and a national service together is assigned a new TS_id at the time the local service is removed from the common TS, the INT and NIT tables should have information related to a list of all services in the TS even though the local services are not provided by the satellite. However, even in this case, the terminal cannot determine which one of the services is a national service, and thus cannot determine which service is available in the national service area and can simply distinguish only the service available in a certain local service area. In the case where the satellite TS and the terrestrial TS have different TS_ids, even though services having the same Service_id are found in the satellite TS and the terrestrial TS, the terminal cannot recognize that they are the same services since Service_id is unique only in one TS.

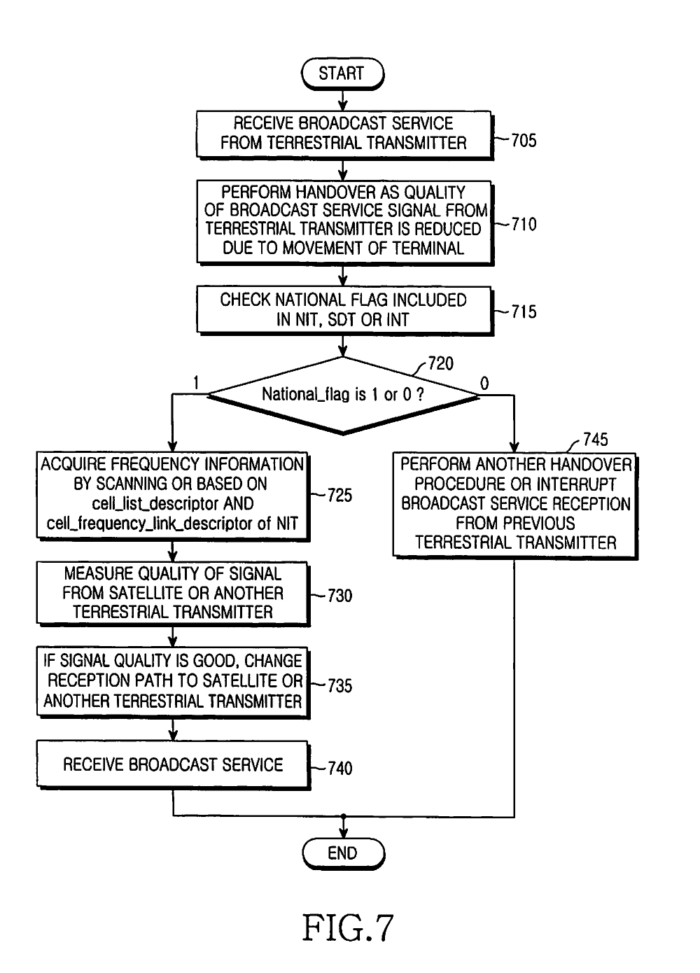

FIG. 7 is a diagram illustrating a handover procedure of a terminal based on Scenario 2 when a national flag is used according to an embodiment of the present invention. In step 705, a user terminal receives a broadcast service from a terrestrial transmitter of a local cell where it is currently located. In step 710, when the user terminal leaves the local cell area where the broadcast service is provided, a quality of the signal received from the terrestrial transmitter is reduced, such that the user terminal determines handover. In step 715, the user terminal checks a national flag included in an NIT, SDT, or INT table as done in embodiments of the present invention, thereby determining if the currently received service is a national service. In step 715, if the national flag of the currently received service is set to ‘1’, the user terminal determines in step 720 that the currently received service is a national service.

In step 725, the user terminal acquires frequency information of the path through which the broadcast service it should continuously receive even after handover is transmitted, by means of Cell_list_descriptor and Cell_frequency_link_descriptor of PSI/SI or by scanning. In step 730, the user terminal measures a signal quality of the satellite or another terrestrial transmitter that provides the national service, using the frequency information acquired in step 725.

If the signal quality measured in step 730 is good (high), the user terminal performs handover to change the reception path of the broadcast service to the satellite or another terrestrial transmitter in step 735, and continuously receives the national service in step 740. At this point, the user terminal has no need to check if a desired broadcast service identifier exists in PSI/SI of the TS transmitted from the cell to which it will perform handover, in order to continuously receive the broadcast service even after handover.

However, if it is determined in step 720 that the national flag is set to ‘0’, the user terminal, identifying that the currently received service is a local service, performs another handover procedure or closes the corresponding service in step 745.

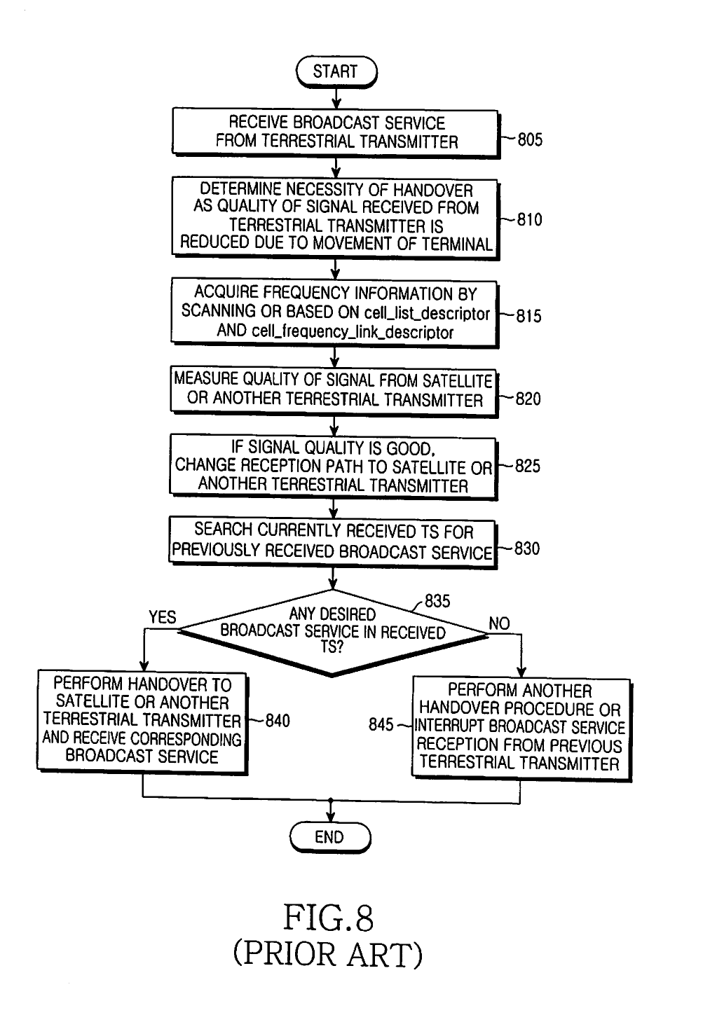

FIG. 8 is a diagram illustrating a conventional handover procedure based on Scenario 2 when the national flag proposed by the present invention is not used. In step 805, a user terminal receives a broadcast service from a terrestrial transmitter. In step 810, when a quality of the signal received from the terrestrial transmitter is less than a predetermined threshold as the user terminal leaves coverage of the terrestrial transmitter, the user terminal determines handover. In step 815, the user terminal acquires frequency information by means of Cell_list_descriptor and Cell_frequency_link_descriptor of an NIT table or by scanning. In step 820, the user terminal measures a quality of the signal from the satellite or another terrestrial transmitter depending on the acquired frequency information.

In step 825, if the quality of the signal received from the satellite or another terrestrial transmitter is good (high), the user terminal changes the path through which it will continuously receive the broadcast service, to a path of the satellite or a path of another terrestrial transmitter. In step 830, the user terminal determines if an identifier of the previously received broadcast service exists in PSI/SI of the currently received TS. However, the user terminal cannot assuredly determine if it can continuously receive the broadcast service it was receiving before its movement, because it cannot certainly determine whether the currently received broadcast service is a national service or a local service. Also, because the PSI/SI is identical, the user terminal cannot determine whether the broadcast service received before its movement and the broadcast service received after its movement are a local service or a national service by checking the PSI/SI.

If it is determined in step 835 that a broadcast service the user terminal desires to receive exists in the TS received after its movement, the user terminal receives the desired broadcast service from the satellite or another terrestrial transmitter in step 840. However, if the desired broadcast service does not exist, the user terminal performs another handover procedure or closes the broadcast service received before its movement in step 845. In this case, when the currently received service is a local service, the reception of the corresponding service is already interrupted after inter-cell movement. Therefore, it can be understood that in order to continue the reception, it is necessary to provide the terminal with information indicating whether it can continue the corresponding service before the inter-cell movement.

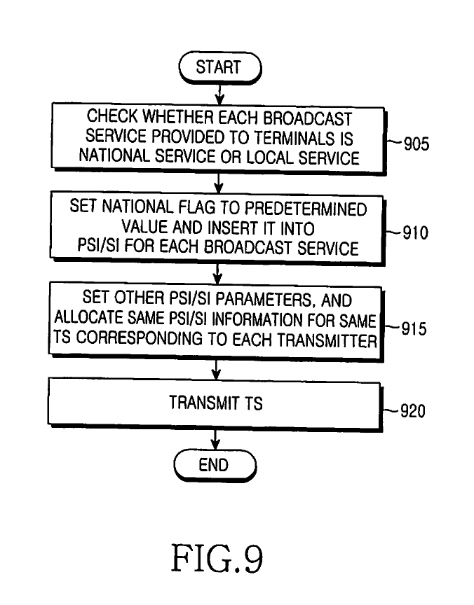

FIG. 9 is a flowchart of a transmission system for generating and transmitting a TS based on Scenario 2 according to an embodiment of the present invention. In step 905, a transmission system determines whether each broadcast service provided to user terminals is a national service or a local service. Based on the determination result, the transmission system sets a national flag to a predetermined value and inserts it into an NIT, SDT, or INT table for each broadcast service in step 910. For example, if the broadcast service is a national service, the transmission system sets the national flag to ‘1’ before transmission, and if the broadcast service is a local service, the transmission system sets the national flag to ‘0’. In step 915, the transmission system sets other PSI/SI parameters corresponding to each transmitter, and allocates the same PSI/SI information for the same TS for each transmitter. In step 920, the transmission system transmits the TS.

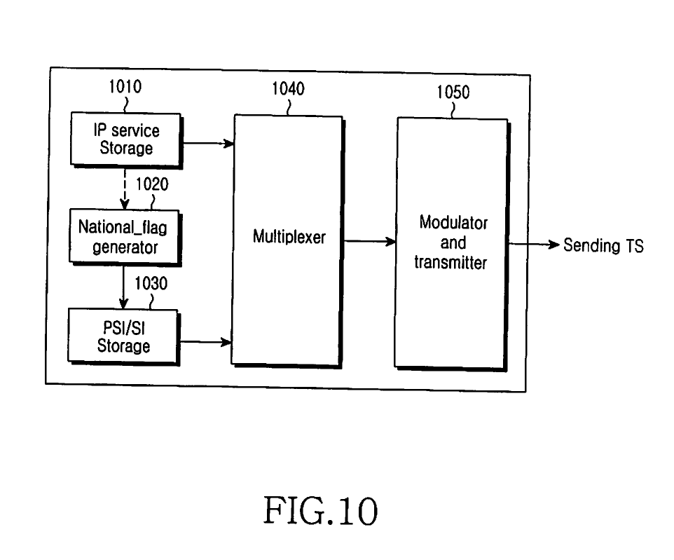

FIG. 10 is a diagram illustrating a structure of a transmission system according to an embodiment of the present invention. The transmission system can be constructed as illustrated in FIGS. 3A and 3B, or can be constructed as illustrated in FIG. 10.

Referring to FIG. 10, an IP service is broadcast service data to be transmitted to a user terminal, and it is stored in an IP service storage 1010. A national flag generator 1020 extracts information indicating whether the broadcast service data is for a national service or for a local service, from the IP service stored in the IP service storage 1010, determines a value of the national flag based on the extracted information, and inserts it into a PSI/SI stored in a PSI/SI storage 1030.

The PSI/SI storage 1030 stores the PSI/SI including the national flag value and other information. A multiplexer 1040 multiplexes the PSI/SI with the broadcast service data read from the IP service storage 1010 and the PSI/SI storage 1030, and a modulator & transmitter 1050 encodes and modulates the multiplexed signal, and transmits the modulated signal.

At this point, the national flag generator 1020, inserts a national flag indicating IF the broadcast service is a national service, into an NIT, SDT, or INT table of PSI/SI information, or inserts a global descriptor into the NIT table before transmission. More specifically, the national flag generator 1020 sets a national flag to a predetermined value according to the service area where the broadcast service is provided, and inserts it into a PSI/SI. That is, the national flag generator 1020 sets the national flag to a predetermined value according to whether the broadcast service is for a national service or for a local service, and inserts it into the PSI/SI stored in the PSI/SI storage 1030.

However, although not illustrated, a PSI/SI generator can combine the PSI/SI with the national flag output from the national flag generator 1020, and output the result to the multiplexer 1040. A combination of the multiplexer 1040 and the modulator & transmitter 1050 will be referred to herein as a transmission unit. The IP service is provided from a content provider (not shown), and the multiplexer 1040 multiplexes broadcast service data, national flag, and PSI/SI, and can be included in service & network head-ends 302 and 312. The multiplexed broadcast service, national flag, and PSI/SI are transmitted after undergoing modulation in the modulator & transmitter 1050. The modulator & transmitter 1050 can be included in broadcast distribution networks 306 and 313, and DVB-SH broadcast head-ends 304 and 314.

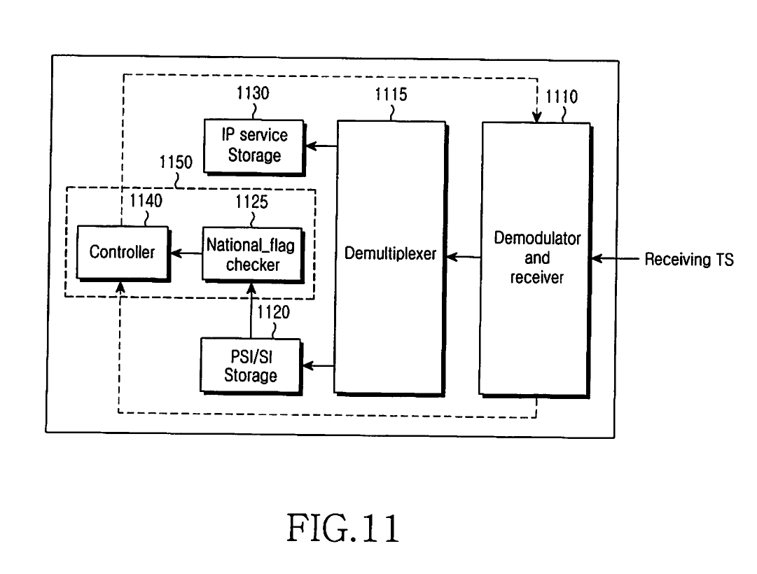

FIG. 11 is a diagram illustrating a structure of a user terminal according to an embodiment of the present invention. Referring to FIG. 11, a demodulator & receiver 1110 receives a signal transmitted from a transmission system, and demodulates and decodes the received signal of broadcast service data and broadcast service information. A demultiplexer 1115 demultiplexes the decoded signal into an IP service of broadcast service data and PSI/SI information that a user terminal needs in receiving the broadcast service data, and stores them in an IP service storage 1130 and a PSI/SI storage 1120, respectively. A national flag checker 1125 checks a national flag or a global descriptor from the received PSI/SI. The national flag checker 1125 checks to which value the national flag is set in an NIT, SDT, or INT table of PSI/SI included in the received TS, or checks whether a global descriptor is inserted in the NIT table, thereby making it possible to determine the area where the received broadcast service is provided. Accordingly, it is possible to determine whether the received broadcast service is for a national service or for a local service.

More specifically, the national flag checker 1125 determines whether the corresponding broadcast service is for a national service or for a local service according to a specific one of the predetermined values, to which the national flag is set, and provides the information acquired in this way to a controller 1140.

When the national flag checker 1125 identifies from the national flag or the global descriptor that the currently received service is a national service, it provides the corresponding information to the controller 1140, and the controller 1140 forwards this information to the demodulator & receiver 1110 in order to adjust hardware parameters so that the user terminal can receive even in the new cell the same broadcast service as the broadcast service previously received in the old cell. In addition, the controller 1140 measures strength of the signal that the demodulator & receiver 1110 has received, and determines to perform handover to another cell if the measured signal strength is lower than a predetermined value. Because this process is well known in the art, a detailed description thereof will be omitted.

When the user terminal needs to handover while receiving the broadcast service data, the controller 1140 determines if the national flag included in a PSI/SI of the currently received TS indicates a national service. If the broadcast service data previously received before handover corresponds to a national service, the controller 1140 controls the demodulator & receiver 1110 in order to receive the TS carrying each broadcast service data after handover and demodulate the broadcast service data previously received before handover in the TS received after handover. The demodulator & receiver 1110 will be referred to herein as a reception unit. Although the controller 1140 and the national flag checker 1125 are separately illustrated in FIG. 11, they can be constructed in one block as indicated by reference numeral 1150. In this case, the national flag checker 1125 is included in the controller 1140.

As is apparent from the foregoing description, the present invention inserts flag or descriptor information indicating if the broadcast service provided to the user terminal is a national service, into the PSI/SI signal before transmission, so that the user terminal can continuously receive the corresponding service. As a result, the user terminal can reduce the time and power required for determining the continuity of the corresponding service during its handover.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for transmitting broadcast service data in a transmission system of a digital broadcasting system, the method comprising:
setting a flag indicating a service area representative of a coverage area in which broadcast service data is provided, for each broadcast service; and
transmitting broadcast service information including the flag and a Transport Stream (TS) including the broadcast service data.

2. The method of claim 1, wherein the broadcast service information is Program Specific Information/Service Information (PSI/SI).

3. The method of claim 2, wherein the flag is set to a predetermined value according to whether each broadcast service data included in the TS is for a national service or for a local service, and inserted into a Network Information Table (NIT) of the PSI/SI.

4. The method of claim 2, wherein the flag is set to a predetermined value according to whether each broadcast service data included in the TS is for a national service or for a local service, and inserted into a Service Description Table (SDT) of the PSI/SI.

5. The method of claim 2, wherein the flag is set to a predetermined value according to whether each broadcast service included in the TS is for a national service or for a local service, and inserted into an Internet Protocol/Media Access Control (IP/MAC) Notification Table (INT) of the PSI/SI.

6. A method for transmitting broadcast service data in a broadcasting system providing a broadcast service as a Transport Stream (TS), wherein broadcast service information of the TS includes information for distinguishing each broadcast service, the method comprising:
when all broadcast service data included in the TS is provided nationwide, generating information indicating that all the broadcast service data included in the TS is broadcast service data provided nationwide;
including the generated information in the broadcast service information of the TS; and
transmitting the broadcast service information along with each broadcast service data.

7. The method of claim 6, wherein the broadcast service information is Program Specific Information/Service Information (PSI/SI).

8. The method of claim 7, wherein the generated information is a global descriptor inserted into a Network Information Table (NIT) of the PSI/SI included in the TS.

9. A method for receiving broadcast service data in a terminal of a digital broadcasting system, the method comprising:
when there is a need for a handover while receiving broadcast service data, checking if a flag is set in broadcast service information, the flag indicating if the currently received broadcast service data is for a national service, and performing handover according to the flag check; and
when broadcast service data received before the handover is for the national service, receiving a Transport Stream (TS) carrying each broadcast service data, and demodulating the broadcast service data received before the handover in the received TS.

10. The method of claim 9, further comprising:
when the flag does not indicate that the broadcast service data is for the national service, checking if there is broadcast service data received before the handover, using information included in broadcast service information of a TS received after the handover; and
when there is broadcast service data received before the handover, demodulating the broadcast service data received before the handover in the TS received after the handover.

11. The method of claim 9, wherein the broadcast service information is Program Specific Information/Service Information (PSI/SI).

12. The method of claim 11, wherein the flag is set to a predetermined value according to whether each broadcast service data included in the TS is for the national service or for a local service, and inserted into a Network Information Table (NIT) of the PSI/SI.

13. The method of claim 11, wherein the flag is set to a predetermined value according to whether each broadcast service data included in the TS is for the national service or for a local service, and inserted into a Service Description Table (SDT) of the PSI/SI.

14. The method of claim 11, wherein the flag is set to a predetermined value according to whether each broadcast service included in the TS is for the national service or for a local service, and inserted into an Internet Protocol/Media Access Control (IP/MAC) Notification Table (INT) of the PSI/SI.

15. A method for receiving broadcast service data in a broadcasting system providing a broadcast service in a Transport Stream (TS), wherein broadcast service information of the TS includes information used for distinguishing each broadcast service, the method comprising:
when there is a need for a handover while receiving the broadcast service data, checking if information is set, the information indicating if all broadcast service data included in the currently received TS is for a national service provided nationwide, and performing the handover according to the information check; and
when all the broadcast service data included in the TS received before the handover is for the national service, receiving a new TS carrying each broadcast service data, and demodulating the broadcast service data received before the handover in the new received TS.

16. The method of claim 15, wherein the broadcast service information is Program Specific Information/Service Information (PSI/SI).

17. The method of claim 16, wherein the information is a global descriptor inserted into a Network Information Table (NIT) of the PSI/SI included in the TS.

18. An apparatus for transmitting broadcast service data to a user terminal in a digital broadcasting system, the apparatus comprising:
a flag generator for setting a flag indicating a service area in which broadcast service data to be transmitted to the user terminal is provided, for each broadcast service; and
a transmission unit for multiplexing broadcast service information including the flag and a Transport Stream (TS) including the broadcast service data, and transmitting the multiplexed TS.

19. The apparatus of claim 18, wherein the broadcast service information is Program Specific Information/Service Information (PSI/SI).

20. The apparatus of claim 19, wherein the flag is set to a predetermined value according to whether each broadcast service data included in the TS is for a national service or for a local service, and inserted into a Network Information Table (NIT) of the PSI/SI.

21. The apparatus of claim 19, wherein the flag is set to a predetermined value according to whether each broadcast service data included in the TS is for a national service or for a local service, and inserted into a Service Description Table (SDT) of the PSI/SI.

22. The apparatus of claim 19, wherein the flag is set to a predetermined value according to whether each broadcast service included in the TS is for a national service or for a local service, and inserted into an Internet Protocol/Media Access Control (IP/MAC) Notification Table (INT) of the PSI/SI.

23. The apparatus of claim 19, wherein when all the broadcast services included in the TS are national services, the flag generator inserts a global descriptor indicating that all the broadcast services included in the TS are the national services, into a Network Information Table (NIT) of the PSI/SI.

24. A terminal apparatus for receiving broadcast service data in a digital broadcasting system, the apparatus comprising:
a reception unit for receiving a Transport Stream (TS), and demodulating broadcast service data and broadcast service information included in the TS;
a demultiplexer for demultiplexing broadcast service information for receiving the demodulated broadcast service data, and broadcast service data to be provided to a user;
a flag checker for checking if a flag indicating if the received broadcast service data is for a national service is inserted into the demultiplexed broadcast service information; and
a controller for controlling the reception unit to perform a handover when there is a need for the handover, and if the flag is inserted, to demodulate broadcast service data received before the handover in a TS received after the handover.

25. The terminal apparatus of claim 24, wherein when the received broadcast service data is not for the national service, the controller checks if information indicating thief a same broadcast service data as broadcast service data received before the handover exists in broadcast service information of the TS received after the handover.

26. The terminal apparatus of claim 24, wherein the broadcast service information is Program Specific Information/Service Information (PSI/SI).

27. The terminal apparatus of claim 26, wherein the flag is set to a predetermined value according to whether each broadcast service data included in the TS is for the national service or for a local service, and inserted into a Network Information Table (NIT) of the PSI/SI.

28. The terminal apparatus of claim 26, wherein the flag is set to a predetermined value according to whether each broadcast service data included in the TS is for the national service or for a local service, and inserted into a Service Description Table (SDT) of the PSI/SI.

29. The terminal apparatus of claim 26, wherein the flag is set to a predetermined value according to whether each broadcast service included in the TS is for the national service or for a local service, and inserted into an Internet Protocol/Media Access Control (IP/MAC) Notification Table (INT) of the PSI/SI.
